(19) United States
(12) Patent Application Publication
(10) Pub. No.: US 2009/0102789 A1
(43) Pub. Date: Apr. 23, 2009

(54) INPUT APPARATUS AND OPERATION METHOD FOR COMPUTER SYSTEM

(75) Inventors: Chin-Chung Kuo, Taipei (TW); Tian-Kai Chang, Taipei (TW); Ling-Chen Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/237,401

(22) Filed: Sep. 25, 2008

(30) Foreign Application Priority Data
Oct. 23, 2007 (TW) 96139697

(51) Int. Cl. G06F 3/033; G09G 5/00; G06F 3/02

(52) U.S. Cl. 345/161; 345/156; 345/168

(57) ABSTRACT

An input apparatus for a computer system is provided. The input apparatus includes a positioning module, a motion detector, and a receiver. The positioning module includes a plurality of positioning light sources, for emitting light rays having a predetermined wavelength. The motion detector includes a G-sensor, and a light sensing unit, for detecting a motion state of the motion detector in a three-dimensional space, and outputting a sensing data. The light sensing unit is provided for receiving the light rays emitted from the positioning light sources. The receiver is coupled to the computer system via a transmission interface, and is adapted for receiving the sensing data outputted from the motion detector via a wireless transmission path. In such a way, the receiver can generate an operation instruction according to the sensing data, and transmit the operation instruction to the computer system via the transmission interface, for operating the computer system.

### CROSS-REFERENCE TO RELATED APPLICATION

This application claims the priority benefit of Taiwan application serial no. 96139697, filed on Oct. 23, 2007. The entirety of the above-mentioned patent application is hereby incorporated by reference herein and made a part of this specification.

### BACKGROUND OF THE INVENTION

1. Field of the Invention

The present invention generally relates to an input apparatus for a computer system, and more particularly, to an input apparatus and an operation method for a computer system allowing a user to input by executing a three-dimensional movement.

2. Description of Related Art

Conventional input apparatuses for computer systems include keyboards, mice, and touch panels. A user of a computer system is usually allowed to input by typing keys of a keyboard, or controlling a mouse to move within a two-dimensional plane, or executing a two-dimensional movement relative to a touch panel.

However, in some specific situations, e.g., when playing computer games, the aforementioned conventional input apparatuses for computer systems are incapable of providing sufficiently convenient inputting. As such, specific input apparatuses are being developed, such as a joystick. Even though such specific input apparatuses bring more interest when playing computer games, they are unfortunately not realistic enough.

### SUMMARY OF THE INVENTION

Accordingly, the present invention is directed to provide an input apparatus for a computer system, which can be universally used for different computer systems and computer game software.

The present invention is further directed to provide an operation method for a computer system, allowing a user to intuitively and realistically operate the computer system.

The present invention provides an input apparatus for a computer system. The input apparatus includes a positioning module, a motion detector, and a receiver. The positioning module includes a plurality of positioning light sources, for emitting light rays having a predetermined wavelength. The motion detector includes a G-sensor, and a light sensing unit, adapted for detecting a motion state of the motion detector in a three-dimensional space, and outputting a sensing data. The light sensing unit is provided for receiving the light rays emitted from the positioning light sources. The receiver is coupled to the computer system via a transmission interface, and is adapted for receiving the sensing data outputted from the motion detector via a wireless transmission path. In such a way, the receiver can generate an operation instruction according to the sensing data, and transmit the operation instruction to the computer system via the transmission interface, for operating the computer system.

Viewing from another point, the present invention further provides an input apparatus for a computer system. The input apparatus includes a positioning module, a primary motion detector, an assistant motion detector, and a receiver. The positioning module includes a plurality of positioning light sources, for emitting light rays having a predetermined wavelength. The primary motion detector includes a G-sensor and a light sensing unit, for detecting a motion state of the primary motion detector in a three-dimensional space, and outputting a first sensing data. The assistant motion detector includes a G-sensor, for detecting a motion state of the assistant motion detector in the three-dimensional space, and outputting the send sensing data. The receiver is coupled to the computer system via a transmission interface, and is adapted for receiving the first sensing data and the second sensing data via a wireless transmission path. In such a way, the receiver can generate an operation instruction according to the first sensing data and the second sensing data, and transmit the operation instruction to the computer system via the transmission interface, for operating the computer system.

According to an embodiment of the present invention, the primary motion detector and the assistant motion detector can mutually exchange information via a wire connection or a wireless connection.

Viewing from another point, the present invention further provides an operation method for a computer system. The operation method includes employing a G-sensor to detect a motion state of an operation terminal, and generating an acceleration data. In another hand, the present invention further detects relative positions between a plurality of positioning light sources and the operation terminal, and correspondingly generates relative position data. Therefore, the present invention can encode the acceleration data and the relative position data to generate a sensing data, and transmit the sensing data from the operation terminal to a receiving terminal via a wireless transmission path. When receiving the sensing data, the receiving terminal transmits the sensing data from the receiving terminal to the computer system via a transmission interface, so as to allow the computer system to be operated according to the sensing data.

According to an embodiment of the present invention, when the receiving terminal receives the sensing data, the operation method further includes: decoding the sensing data, for recovering the acceleration data and the relative position data, and decoding the acceleration data and the relative position data, respectively, to obtain a motion information and a virtual coordinate information. Further, the present invention generates a motion instruction according to the motion information. An operation instruction can be generated by encoding the motion instruction and the virtual coordinate information. Further, the operation instruction can be transmitted to the computer system via a transmission interface, for operating the computer system.

According to an embodiment of the present invention, the transmission interface can be a universal serial bus (USB), an IEEE 1394 interface, a serial port interface, a parallel port interface, or a personal computer memory card international association (PCMCIA) interface.

The input apparatus according to the present invention includes a light sensing unit and a G-sensor, and thus is adapted for detecting a motion state of a motion detector in a three-dimensional space. Therefore, the user is allowed to more institutively, more realistically, and more freely operate the compute system. The present invention further employs a receiver, for coupling with the computer system via a universal purpose transmission interface. In such a way, the present invention is adapted for universally applying for different kinds of computer application software or games.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an input apparatus for a computer system according to a first embodiment of the present invention.

FIG. 2A is a top view of a motion detector according to a preferred embodiment of the present invention.

FIG. 2B is a side view of a motion detector according to a preferred embodiment of the present invention.

FIG. 3 is a block diagram illustrating an inner circuit of a motion detector according to a preferred embodiment of the present invention.

FIG. 4 is a flow chart illustrating a procedure of detecting a motion state of the motion detector according to a preferred embodiment of the present invention.

FIGS. 5A through 5D are schematic diagrams illustrating the principle of obtaining a relative position of the motion detector by positioning light sources according to a preferred embodiment of the present invention.

FIG. 6 is a block diagram illustrating an inner circuit of a receiver according to a preferred embodiment of the present invention.

FIG. 7 is a flow chart illustrating a procedure of processing a sensing data according to a preferred embodiment of the present invention.

FIG. 8 is a block diagram illustrating an input apparatus for a computer system according to a second embodiment of the present invention.

FIG. 9A is a top view of an assistant motion detector according to a preferred embodiment of the present invention.

FIG. 9B is a side view of an assistant motion detector according to a preferred embodiment of the present invention.

FIG. 10 is a block diagram illustrating an inner circuit of an assistant motion detector according to a preferred embodiment of the present invention.

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

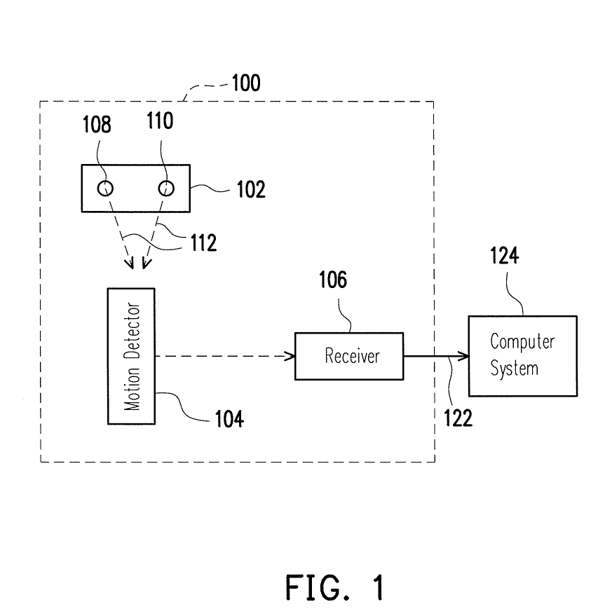

FIG. 1 is a block diagram illustrating an input apparatus for a computer system according to a first embodiment of the present invention. Referring to FIG. 1, it shows an input apparatus 100 connected with a computer system 124 via a universal transmission interface 122. The input apparatus 100 includes a positioning module 102, a motion detector 104, and a receiver 106. The motion detector 104 is adapted for detecting a relative position of the motion detector 104 relative to the positioning module 102, and mutually transmitting information with the receiver 106. The receiver 106 is coupled to the computer system via the transmission interface 122. According to an aspect of the embodiment, the positioning module 102 can be disposed together with the computer system 124, or disposed in front of a user in operation.

The positioning module 102 includes a plurality of light sources. In the current embodiment, the positioning module 102 includes positioning light sources 108 and 110. The positioning light sources 108 and 110 are adapted for emitting light rays 112 having a specific wavelength. Therefore, the motion detector 104 can detect the light rays emitted from the positioning light sources 108 and 110, so as to confirm the relative position to the positioning module 102.

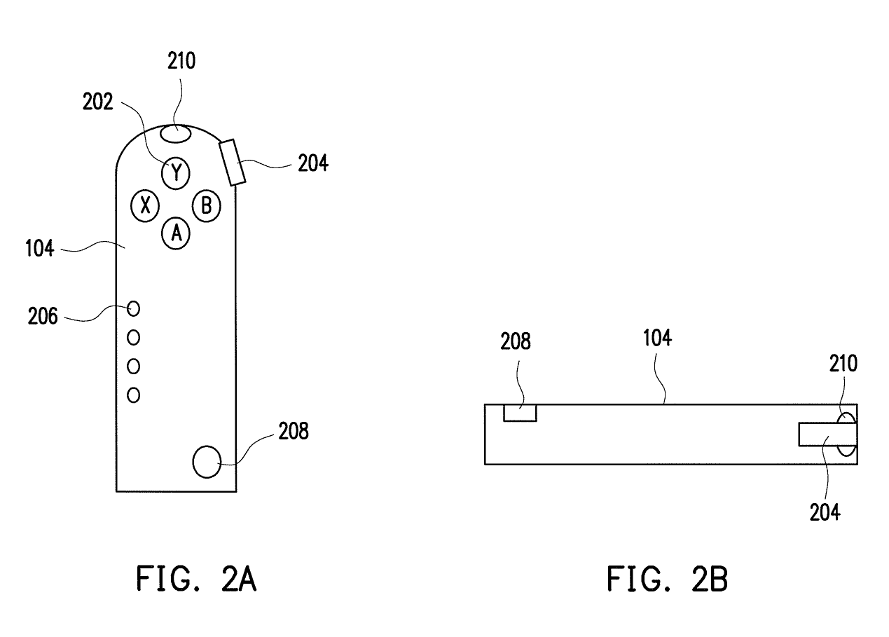

FIG. 2A is a top view of a motion detector according to a preferred embodiment of the present invention. FIG. 2B is a side view of a motion detector according to a preferred embodiment of the present invention. Referring to FIGS. 2A and 2B together, the motion detector 104 includes a plurality of functional keys, e.g., 202, 204, 206, and 208. When different functional keys are pressed down, the motion detector 104 will be raised for a corresponding motion, respectively. For example, when the functional key 208 is enabled, it represents that a power supply of the motion detector 108 is turned on.

Further, the motion detector 104 can be provided with a light sensing unit 210. The light sensing unit 210 can be used for sensing the light rays 112 emitted from the positioning light sources 108 and 110 as shown in FIG. 1. In such a way, the motion detector 104 can learn the relative position of itself relative to the positioning module 104. The positioning principle will be discussed in more details herebelow.

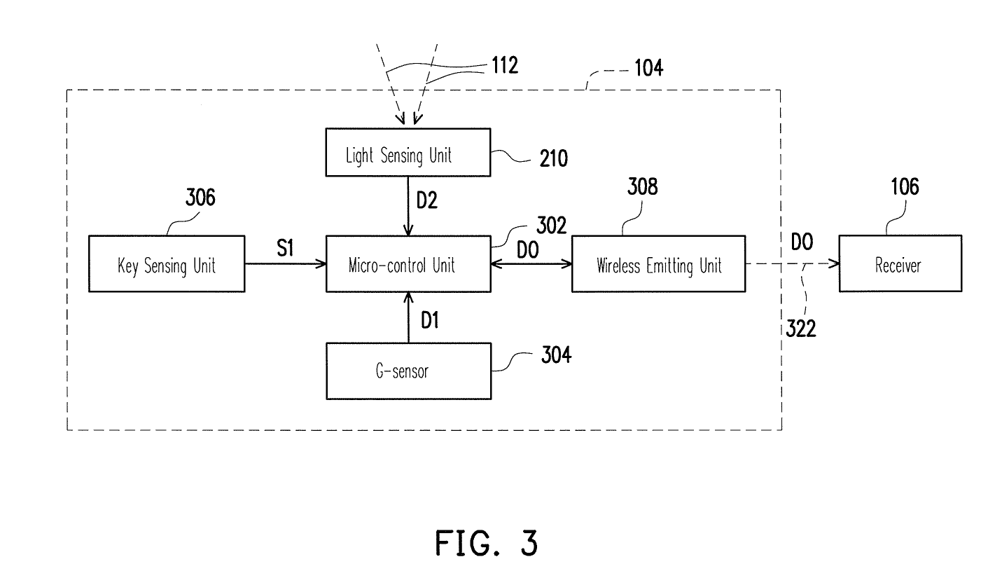

FIG. 3 is a block diagram illustrating an inner circuit of a motion detector according to a preferred embodiment of the present invention. Referring to FIG. 3, the motion detector 104 includes a micro-control unit 302 coupling to the light sensing unit 210, a G-sensor 304, a key sensing unit 306, and a wireless emitting unit 308. The wireless emitting unit 308 is adapted to connect with the receiver 106 via a wireless transmission path 322. The wireless transmission path 322 for example can be an infrared ray (IR) transmission path, a BLUETOOTH® transmission path, or a wireless network transmission path.

In the current embodiment, the user is allowed to operate the computer system 124 by controlling the motion of the motion detector 104 in the three-dimensional space. When the user waves the motion detector 104 in the three-dimensional space, the micro-control unit 302 detects a motion state of the motion detector 104 by the light sensing unit 210 and the G-sensor 304, and transmits the detected result to the receiver 106 via the wireless emitting unit 308.

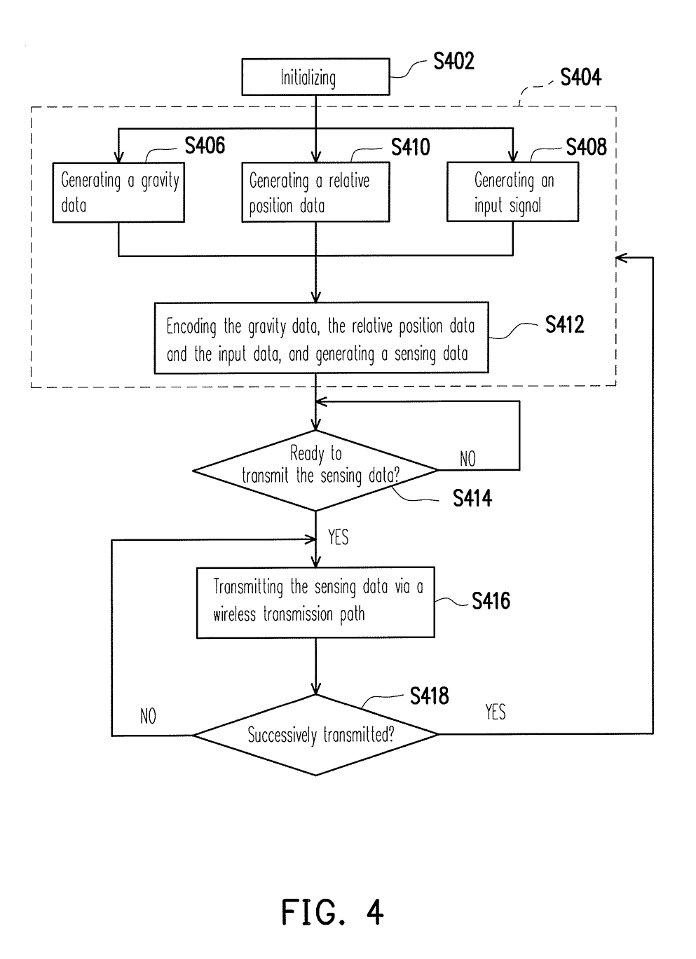

FIG. 4 is a flow chart illustrating a procedure of detecting a motion state of the motion detector according to a preferred embodiment of the present invention. Referring to FIGS. 3 and 4 together, when the power supply of the motion detector 104 is turned on, an initialization is performed at step S402. Then, at step S404, the micro-control unit 302 generates a sensing data DO according to the motion state of the motion detector 104 in the three-dimensional space.

Specifically, the step of generating the sensing data DO is discussed as following. In the current embodiment, the G-sensor 304 is capable of detecting accelerations of the motion detector 104 with respecting to different coordinate axes of the three-dimensional space, and at step S406 the G-sensor 304 generates a gravity data D1 and provides the gravity data D1 to the micro-control unit 302. Further, the key sensing unit 306 is adapted for detecting a state of each of the keys of the motion detector 104. When one of the keys is enabled, the key sensing unit 306 generates a corresponding input signal S1 at step S408, and provides the input signal S1 to the micro-control unit 302. Further, when the light sensing unit 210 receives light rays 112 emitted from the positioning light sources 108 and 110, as shown in FIG. 1, the light sensing unit 210 generates a relative position data D2, and provides the relative position data D2 to the micro-control unit 302.

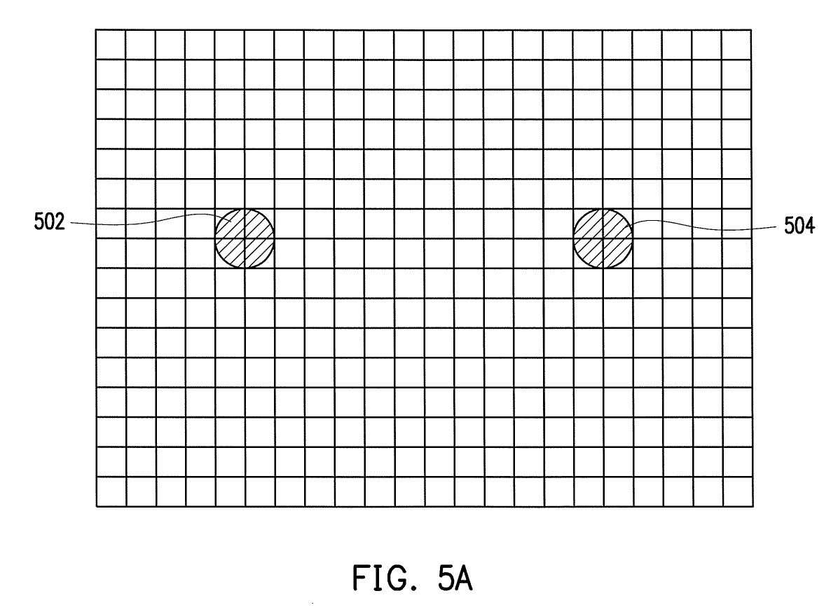

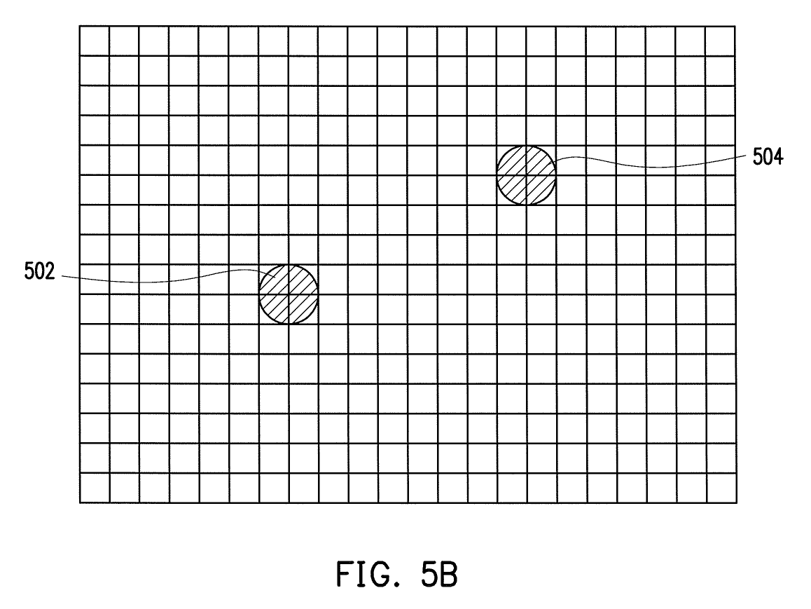

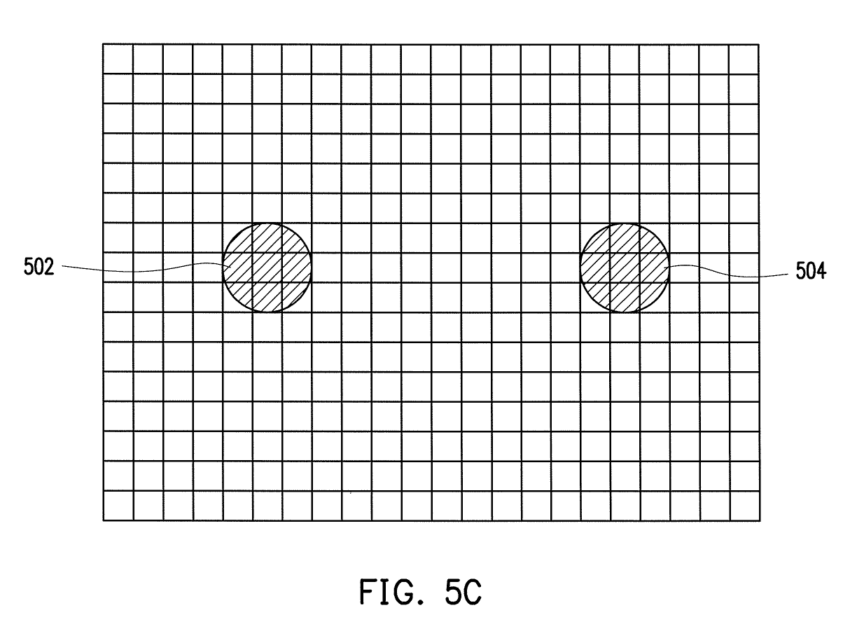

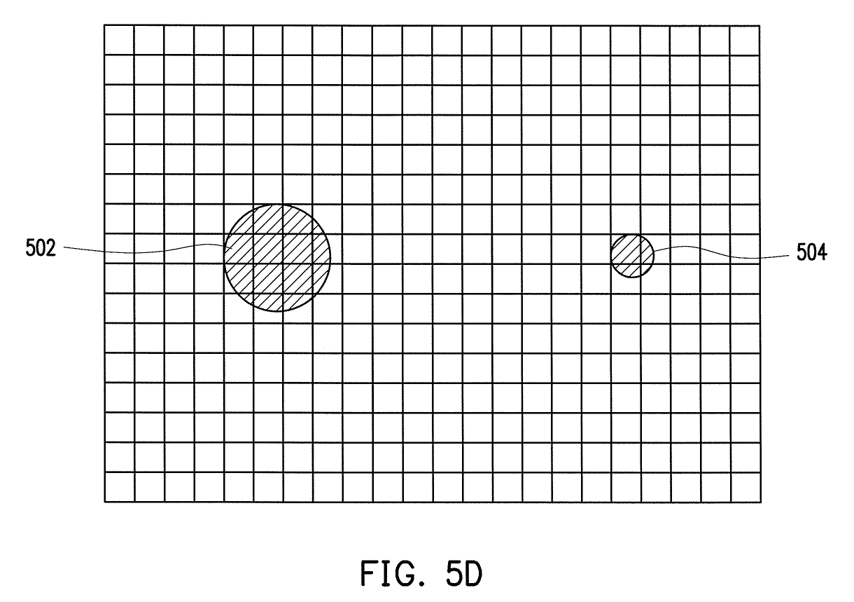

FIGS. 5A through 5D are schematic diagrams illustrating the principle of obtaining a relative position of the motion detector by positioning light sources according to a preferred embodiment of the present invention. First, referring to FIG. 5A, in the current embodiment, the light sensing unit 210 is set with a predetermined resolution. When the motion detector 104 of FIG. 3 performs step S402, the user can align the light sensing unit 210 with the positioning light sources 108 and 110. Meanwhile, the light rays emitted from the positioning light sources 108 and 110 configure two light spots 502 and 504 on the light sensing unit 210. In this case, the micro-control unit 302 can of define a virtual origin, according to positions of the light spots 502 and 504 configured on the light sensing unit 210. When the positions of the light spots 502 and 504 configured on the light sensing unit 210 vary, the light sensing unit 210 outputs a relative position data D2 to the micro-control unit 302. In such a way, when comparing current positions of the light spots 502 and 504 with the virtual original according to the relative position data D2, the relative position of the motion detector 104 relative to the positioning light sources 108 and 110 can be known.

Referring to FIG. 5B, and comparing FIG. 5B with FIG. 5A, it can be found that the light spot 502 of FIG. 5A downward and rightward moves for a certain distance in FIG. 5B, and the light spot 504 of FIG. 5A upward and leftward moves for a certain distance in FIG. 5B. This may indicate that the user has turned the motion detector 104 for a specific angle.

Referring to FIG. 5C, and comparing FIG. 5C with the status of the light spots 502 and 504 as shown in FIG. 5A, it can be found that the light spots 502 and 504 are apparently larger than that shown in FIG. 5A. This may indicate that the user has moved the motion detector 104 to approach to the positioning light sources 108 and 110.

Referring to FIG. 5D, and comparing FIG. 5D with the status of the light spots 502 and 504 as shown in FIG. 5A, it can be found that the light spot 502 become larger and the light spot 504 become smaller than that shown in FIG. 5A. This may indicate that the user has pointed the motion detector 104 toward one of the positioning light sources 108 and 110.

Referring to FIGS. 3 and 4 again, when the micro-control unit 302 receives the gravity data D1, the relative position data D2, and the input signal S1, the micro-control unit 302 can encode the gravity data D1, the relative position data D2, and the input signal S1 into a sensing data DO according to a predetermined data sequence, and transmits the sensing data DO to the wireless emitting unit 308. Meanwhile, the micro-control unit 302 determines whether the wireless emitting unit 308 is ready for transmitting the sensing data DO at step S414.

If the micro-control unit 302 determines that the wireless emitting unit 308 is incapable of transmitting the sensing data DO (i.e., the result of the step S414 is shown as “NO”), because of a certain reason, (e.g., the wireless transmitting path 322 suffering a large interference), the micro-control unit 302 keeps waiting. When the micro-control unit 302 determines that the wireless emitting unit 308 is ready for transmitting the sensing data DO (i.e., the result of the step S414 is shown as “YES”), then at step S410 the wireless emitting unit 308 transmits the sensing data DO to the receiver 106 via the wireless transmission path 322. Further, the micro-control unit 302 may also determine whether the sensing data DO has been successively transmitted at step S418.

If the micro-control unit 302 determines that the sensing data DO has not yet been successively transmitted (i.e., the result of the step S418 is shown as “NO”), the step S416 is repeated. Otherwise, if the micro-control unit 302 determines that the sensing data DO has been successively transmitted (i.e., the result of the step S418 is shown as “YES”), the steps S404 . . . are repeated for keeping to transmit the latest sensing data to the receiver 106.

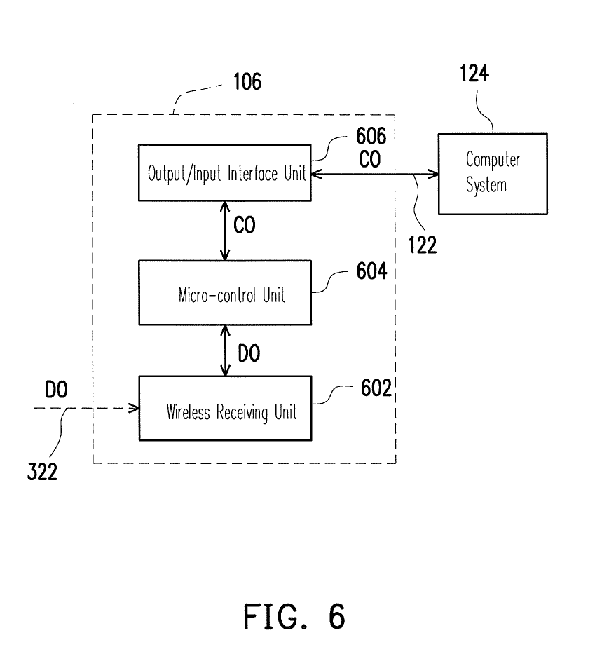

FIG. 6 is a block diagram illustrating an inner circuit of a receiver according to a preferred embodiment of the present invention. Referring to FIG. 6, the receiver 106 includes a wireless receiving unit 602, a micro-control unit 604, and an input/output interface unit 606. The micro-control unit 604 is coupled to the wireless receiving unit 602 and the input/output interface unit 606. The wireless receiving unit 602 is adapted for receiving the sensing data DO via the wireless transmission path 322. The input/output interface unit 606 is coupled to the computer system 124 via the transmission interface 122. In the current embodiment, the transmission interface 122 can be a universal serial bus (USB), an IEEE 1394 interface, a serial interface, a parallel interface, or a personal computer memory card international association (PCMCIA) interface. Correspondingly, the input/output interface unit 606 can be configured as different types of ports in accordance with configuration of the transmission interface 122.

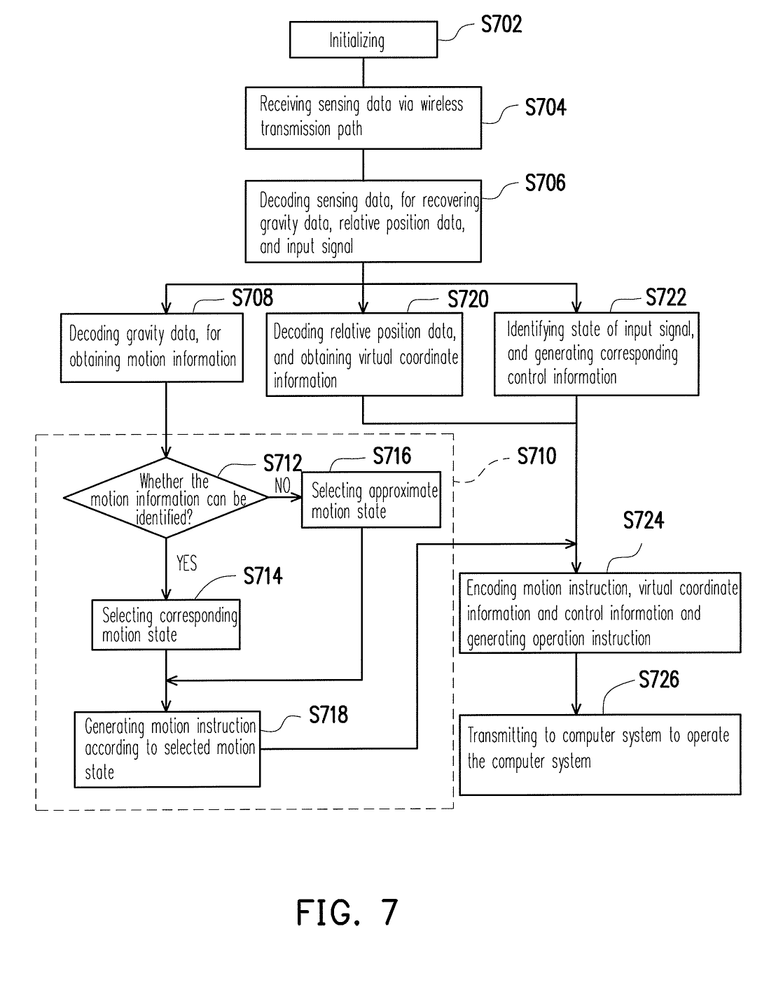

FIG. 7 is a flow chart illustrating a procedure of processing a sensing data according to a preferred embodiment of the present invention. Referring to FIGS. 6 and 7 together, when the receiver 106 is connected to the computer system 124, and is enabled accordingly, the receiver 106 starts for initialization at step S702, e.g., the motion detector 104 building the wireless transmission path 322 as shown in FIG. 1. Then, after the initialization of the receiver 106 is completed, at step S704, the receiver 106 receives the sensing data DO via the wireless transmission path 322. Meantime, the wireless receiving unit 602 transmits the sensing data DO to the micro-control unit 604, for decoding the sensing data DO at step S706, to recover the gravity data D1, the relative position data D2, ad the input signal S1, as shown in FIG. 3.

Then, at step S708, the micro-control unit 604 further decodes the gravity data D1 to obtain a motion information. The motion information includes acceleration values obtained by the G-sensor 304 in the three-dimensional space with respect to different coordinate axles. Further, at step S710, the micro-control unit 604 generates a motion instruction.

Specifically, after obtaining the motion information, at step S712, the micro-control unit 604 determines whether the motion information can be identified. If the micro-control unit 604 can identify the motion information (i.e., the result of the step S712 is shown as “YES”), at step S714, a corresponding motion state is selected (i.e., a linear motion or an arcuate motion). Or otherwise, if the micro-control unit 604 cannot identify the motion information (i.e., the result of the step S712 is shown as “NO”), an approximate motion state is selected according to the calculated motion states at step S716. In such a way, the micro-control unit 604 generates a motion instruction according to the selected motion state.

In addition to decoding the gravity data D1, the micro-control unit 604 further decodes the relative position data D2 at step S720, to obtain a virtual coordinate information, and identifies a state of the input signal generated by the user pressing keys of the motion detector 104 at step S722, to obtain a corresponding control information. Therefore, the micro-control unit 604 performs step S724 to encode the motion instruction, the virtual coordinate information, and the control information, and generate an operation instruction CO, and provide the operation instruction CO to the input/output interface unit 606. When receiving the operation instruction CO, the input/output interface unit 606 transmits the operation instruction CO to the computer system 124 via the transmission interface 122, so as to operate the computer system 124 according to the operation instruction CO. Embodiments are to be given below for exemplifying the step S710.

### Embodiment 1

If the user is controlling the computer system 124 with a mouse or a keyboard, when he intends to move a cursor rightward on the display, he should rightward move the mouse on a plane, or enable a right arrow key for controlling the cursor to rightward move on the display of the computer system.

However, if the user is using the input apparatus 100 as shown in FIG. 1, he can move the cursor rightward on the display simply by rightward moving the motion detector 104 in the three-dimensional space. In this case, the G-sensor 304 as shown in FIG. 3 of the motion detector 104 detects accelerations occurred on two coordinate axles of the three-dimensional space, and outputs a corresponding gravity data D1. Further, the light sensing unit 210 detects latest relative positions of the positioning light sources 108 and 110 relative to the light sensing unit 210, and outputs a corresponding relative position data D2. Meanwhile, the motion detector 104 generates a sensing data DO according to the gravity data D1 and the relative position data D2, and provides the sensing data DO to the receiver 106.

After receiving the sensing data DO, the receiver 106 decodes the gravity data D1 and the relative position data D2, and respectively obtains the corresponding motion instruction and virtual coordinate information. Accordingly, the micro-control unit 604 generates an operation instruction CO according to the motion instruction and the virtual coordinate information. The operation instruction CO is comparatively equivalent with the signal generated by the enabled right arrow key of the keyboard, or the instruction generated by the mouse when it detects that it is being moved right ward on a plane. In such a way, when the receiver 106 transmits the operation instruction CO to the computer system 124 via the transmission interface 122, the computer system 124 understand the operation instruction CO like the above-exampled instruction or signal emitted by the keyboard or the mouse. Likewise, the cursor of the computer system 124 is controlled to rightward move in accordance with the user's operation.

### Embodiment 2

When the user is going to play a computer game, e.g., baseball game, with the computer system 124, and if he controls the game by operating the keyboard, he has to press a specific key, e.g., “ENTER” key, for controlling an action of the bat, e.g., swinging bat.

Comparatively, when using the motion detector 104 of the input apparatus of the current embodiment for operation, the user swings the motion detector 104, so that the G-sensor 304 of the motion detector 104 detects accelerations occurred at the three coordinate axles of the three-dimensional space. As such, the G-sensor 304 generates a corresponding gravity data D1 according to the acceleration value of each coordinate axis. Further, the light sensing unit 210 generates a relative position data D2 according to the latest relative positions of the positioning light sources 108 and 110 relative to the light sensing unit 210. Accordingly, the motion detector 104 generates a corresponding sensing data DO.

When receiving the sensing data DO, the receiver 106 similarly decodes to obtain the gravity data and the relative position data, and generates a corresponding motion instruction and virtual coordinate information. Meanwhile, the receiver 106 outputs the corresponding operation instruction CO, and provides the operation instruction CO to the computer system 124. The operation instruction CO corresponds to the instruction generated by the keyboard when the “ENTER” key is pressed. As such, when receiving such an operation instruction CO, the computer system 124 understands it as an instruction of swinging bat inputted by the user. In such a way, the user is allowed to operate the computer game software being played on the computer system 124 by operating the motion detector 104.

In some embodiments, different actions as mentioned above can be set in the step S402 of FIG. 4, or in the step S702 of FIG. 7. In such a way, the user can freely set each action in correspondence with different operations of the computer system 124 as desired.

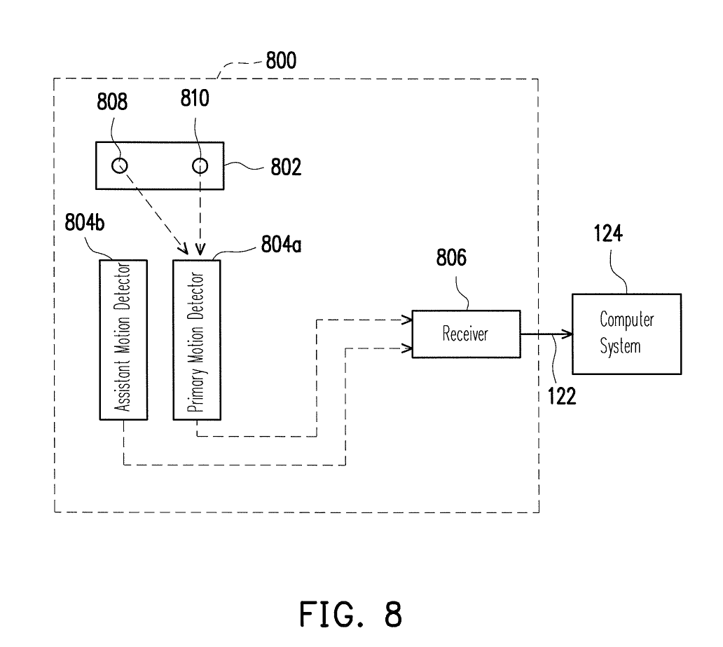

FIG. 8 is a block diagram illustrating an input apparatus for a computer system according to a second embodiment of the present invention. Referring to FIG. 8, an input apparatus 800 similarly includes a positioning module 802, and a receiver 806. The positioning module 802 similarly includes positioning light sources 808 and 810, adapted for emitting light rays having a predetermined wavelength. The receiver 806 is similarly coupled to the computer system 124 via the transmission interface 122. However, the input apparatus 800 differs from the input apparatus 100 of FIG. 1 in that the input apparatus 800 includes a primary motion detector 804a and an assistant motion detector 804b. The primary motion detector 804a has the same principle and function as that of the motion detector 104 of the first embodiment.

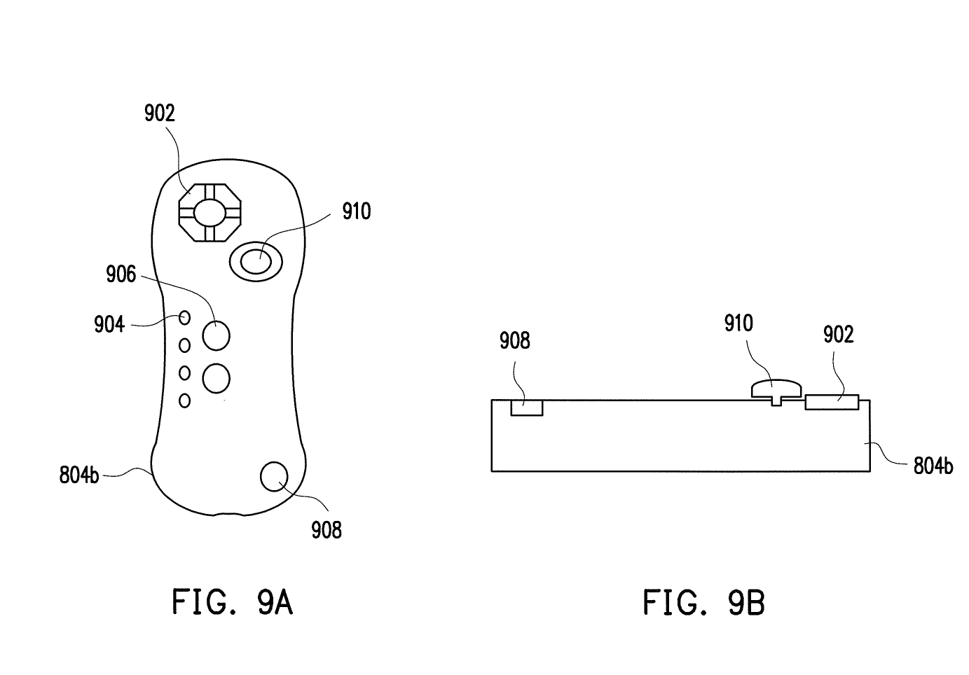

The appearance and configuration of the primary motion detector 804a can be learnt by referring to FIGS. 2A and 2B as well as the related context, while the appearance and configuration of the assistant motion detector 804b can be learnt by referring to FIGS. 9A and 9B. FIG. 9A is a top view of an assistant motion detector according to a preferred embodiment of the present invention. FIG. 9B is a side view of an assistant motion detector according to a preferred embodiment of the present invention. Referring to FIGS. 9A and 9B, the assistant motion detector 804b is equipped with a plurality of functional keys, e.g., 902, 904, 906, and 908. For example, the functional key 902 is a four-axis directional key, and the functional key 908 is a power key. Specifically, the assistant motion detector 804b is provided with a joystick 910.

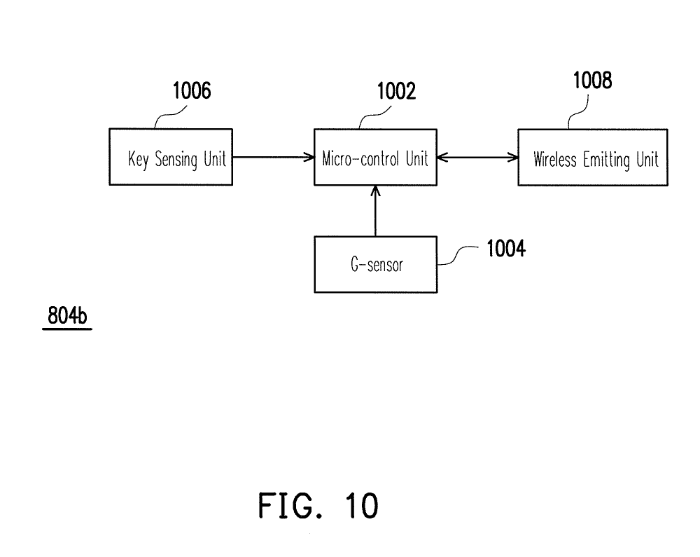

Further, the inner circuit and principle of the primary motion detector 804a can be learnt by referring to FIGS. 3 and 4 as well as the related context, while the inner circuit and principle of the assistant motion detector 804b can be learnt by referring to FIG. 10. FIG. 10 is a block diagram illustrating an inner circuit of the assistant motion detector 804b according to a preferred embodiment of the present invention. Referring to FIG. 10, the assistant motion detector 804b includes a control unit 1002, a G-sensor 1004, a key sensing unit 1006, and a wireless emitting unit 1008. In the current embodiment, the coupling correlation and operation principle of the control unit 1002, the G-sensor 1004, the key sensing unit 1006, and the wireless emitting unit 1008 are substantially equivalent with that of the micro-control unit 302, the G-sensor 304, the key sensing unit 306, and the wireless emitting unit 308 of FIG. 3. The only difference therebetween is that the assistant motion detector 804b is provided with a joystick. Therefore, the key sensing unit 1006 is further responsible for detecting the state of the joystick, and generating a corresponding input signal. Further, in the current embodiment, the assistant motion detector 804b is similar as discussed in the foregoing embodiment, in that it can directly transmit data via the wireless emitting unit to the receiver coupling with the computer system. In some other embodiments, the assistant motion detector 804b can also mutually transmit information with the primary motion detector 804a via the wireless emitting unit 1008.

It can be learnt from the foregoing discussion that the primary motion detector 804a and the assistant motion detector 804b generate corresponding sensing data respectively, and provide the corresponding sensing data to the receiver 806, respectively. As such, when performing the initialization, e.g., step S702 of FIG. 7, the receiver 806 needs to verify the primary motion detector 804a and the assistant motion detector 804b of identifying a sensing data as generated by the primary motion detector 804a or by the assistant motion detector 804b. The inner circuit and operation principle of the receiver 806 can be learnt by those skilled in the art by referring FIGS. 6 and 7 as well as the related context.

In summary, the motion detector employed in the embodiment of the present invention includes a light sensing unit and a G-sensor, and therefore is capable of detecting a motion trend of the motion detector. As such, when operating the input apparatus according to the embodiments of the present invention, the user can more conveniently, more institutively, and more realistically operate the computer system. Further, the receiver of the embodiment of the present invention is connected to the computer system via a universal serial bus (USB) interface, an IEEE 1394 interface, a serial port interface, a parallel port interface, or a personal computer memory card international association (PCMCIA) interface. As such, the embodiments of the present invention can be applied for different computer systems, and would not be restricted to any specific host. Further, the present invention allows the user to set different motion modes for operating the computer system when initializing, and therefore the present invention is also adapted for different application software.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input apparatus for a computer system, comprising:
a positioning module, comprising a plurality of positioning light sources, for emitting light rays having a predetermined wavelength;
a motion detector, comprising a G-sensor and a light sensing unit, the G-sensor and the light sensing unit being adapted for detecting a motion state of the motion detector in a three-dimensional space, and outputting a sensing data, wherein the light sensing unit is adapted for receiving the light rays emitted from the positioning light sources; and
a receiver, coupled to the computer system via a transmission interface, and adapted for receiving the sensing data via a wireless transmission path, so as to generate an operation instruction according to the sensing data, and transmit the operation instruction to the computer system via the transmission interface.

2. The input apparatus according to claim 1, wherein the motion detector further comprises:
a plurality of keys;
a key sensing unit, for detecting a state of each of the keys, and outputting a corresponding input signal;
a micro-control unit, coupled to the key sensing unit, the light sensing unit, and the G-sensor, for encoding the input signal, and outputs of the light sensing unit and the G-sensor, to generate the sensing data; and
a wireless emitting unit, coupled to the micro-control unit, for receiving the sensing data, and transmitting the sensing data to the receiver via the wireless transmission path.

3. The input apparatus according to claim 1, wherein the receiver comprises:
a wireless receiving unit, for receiving the sensing data via the wireless transmission path;
a micro-control unit, coupled to the wireless receiving unit, for decoding the sensing data, and generating a corresponding operation instruction; and
an input/output interface unit, coupled to the computer system via the transmission interface, and coupled to the micro-control unit, for transmitting the operation instruction to the computer system via the transmission interface.

4. The input apparatus according to claim 1, wherein the transmission interface is a universal serial bus (USB) interface, an IEEE 1394 interface, a serial port interface, a parallel port interface, or a personal computer memory card international association (PCMCIA) interface.

5. An input apparatus for a computer system, comprising:
a positioning module, comprising a plurality of positioning light sources, for emitting light rays having a predetermined wavelength.
a primary motion detector, comprising a first G-sensor and a first light sensing unit, for detecting a motion state of the primary motion detector in a three-dimensional space, and outputting a first sensing data, wherein the first light sensing unit is adapted for receiving the light rays emitted from the positioning light sources;
an assistant motion detector, comprising a second G-sensor, for detecting a motion state of the assistant motion detector in the three-dimensional space, and outputting a second sensing data; and
a receiver, coupled to the computer system via a transmission interface, and receiving the first sensing data and the second sensing data via a wireless transmission path, so as to generate an operation instruction according to the first sensing data and the second sensing data, and transmit the operation instruction to the computer system via the transmission interface.

6. The input apparatus according to claim 5, wherein the primary motion detector comprises:
a plurality of first keys;
a first key sensing unit, for detecting a state of each of the first keys, and outputting a corresponding first input signal;
a first micro-control unit, coupled to the first key sensing unit, the first light sensing unit, and the first G-sensor, for encoding the first input signal, and outputs of the first light sensing unit and the first G-sensor, to generate the first sensing data; and
a first wireless emitting unit, coupled to the first micro-control unit, for receiving the first sensing data, and transmitting the first sensing data to the receiver via the wireless transmission path.

7. The input apparatus according to claim 5, wherein the assistant motion detector comprises:
a plurality of second keys;
a joystick;
a second key sensing unit, for detecting a state of each of the second keys and the joystick, and outputting a corresponding second input signal;
a second micro-control unit, coupled to the second key sensing unit, the first light sensing unit, and the second G-sensor, for encoding the second input signal, and an output of the second G-sensor, to generate the second sensing data; and
a second wireless emitting unit, coupled to the second micro-control unit, for receiving the second sensing data, and transmitting the second sensing data to the receiver via the wireless transmission path.

8. The input apparatus according to claim 5, wherein the primary motion detector and the assistant motion detection mutually exchange information via a wireless connection.

9. The input apparatus according to claim 5, wherein the primary motion detector and the assistant motion detection mutually exchange information via a wire connection.

10. The input apparatus according to claim 5, wherein the receiver comprises:
a wireless receiving unit, for receiving the first sensing data and the second sensing data via the wireless transmission path;
a micro-control unit, coupled to the wireless receiving unit, for decoding the first sensing data and the second sensing data, and generating a corresponding operation instruction; and
an input/output interface unit, coupled to the computer system via the transmission interface, and coupled to the micro-control unit, for transmitting the operation instruction to the computer system via the transmission interface.

11. The input apparatus according to claim 5, wherein the transmission interface is a universal serial bus (USB) interface, an IEEE 1394 interface, a serial port interface, a parallel port interface, or a personal computer memory card international association (PCMCIA) interface.

12. An operation method for a computer system, comprising:
employing a G-sensor to detect a motion state of an operation terminal, and generating a gravity data;
detecting relative positions of a plurality of positioning light sources relative to the operation terminal, and generating a relative position data;
encoding the gravity data and the relative position data, and generating a sensing data;
transmitting the sensing data from the operation terminal to a receiving terminal via a wireless transmission path; and
transmitting the sensing data from the receiving terminal to the computer system via a transmission interface, so as to operate the computer system according to the sensing data.

13. The operation method according to claim 12, wherein the step of transmitting the sensing data to the receiving terminal further comprises:
determining whether or not the sensing data is ready for transmitting, when obtaining the sensing data;
transmitting the sensing data to the receiving terminal via the wireless transmission path, when the sensing data is ready for transmitting; and
repeating the steps of receiving the sensing data for obtaining a latest sensing data, when the sensing data is transmitted successively.

14. The operation method according to claim 12, when the receiving terminal receives the sensing data, further comprising:
decoding the sensing data, for recovering the gravity data and the relative position data;
decoding the gravity data to obtain a motion information;
generating a motion instruction according to the motion information;
decoding the relative position data, to obtain a virtual coordinate information;
encoding the motion instruction and the virtual coordinate information, to generate an operation instruction; and
transmitting the operation instruction to the computer system via the transmission interface, for operating the computer system.

15. The operation method according to claim 14, wherein the step of generating the motion instruction further comprises:
determining whether or not the motion information can be identified, when obtaining the motion information;
if the motion information can be identified, then selecting a corresponding motion state; and
if the motion information cannot be identified, then selecting an approximate motion state; and
generating the motion instruction according to the selected motion state.

16. The operation method according to claim 12, wherein the operation terminal comprises a plurality of functional keys and a joystick input interface.

17. The operation method according to claim 16, further comprising:
detecting states of the functional keys and the joystick interface, and obtaining an input signal; and
encoding the gravity data, the relative position data, and the input signal together for generating the sensing data.

18. The operation method according to claim 12, wherein the transmission interface is a universal serial bus (USB) interface, an IEEE 1394 interface, a serial port interface, a parallel port interface, or a personal computer memory card international association (PCMCIA) interface.
